(19) United States
(12) Patent Application Publication
(10) Pub. No.: US 2001/0007832 A1
(43) Pub. Date: Jul. 12, 2001

(54) Constant-velocity joint with a boot

(76) Inventor: Shinichi Takabe, Shizuoka (JP)

Correspondence Address: WENDEROTH, LIND & PONACK, L.L.P., Suite 800, 2033 "K" Street, N.W., Washington, DC, 20006, US

(21) Appl. No.: 09/725,755

(22) Filed: Nov. 30, 2000

(30) Foreign Application Priority Data
Nov. 30, 1999 (JP) 11-340530

(51) Int. Cl. F16D 1/00; F16N 1/00; F16C 1/24

(52) U.S. Cl. 464/15

(57) ABSTRACT

A constant-velocity joint having a boot and containing a lubricating grease that will not deteriorate the boot of the CVJ while maintaining required torque transmission performance. The constant-velocity joint is filled with a lubricating grease, and the tubular boot is made from a thermoplastic polyester elastomer. The grease contains a base oil, a thickener in the form of a lithium soap such as lithium 12 hydroxystearate or a lithium complex, and extreme-pressure additives in the form of molybdenum disulfide, molybdenum alkyldithiocarbamate and zinc dithiocarbamate.

### BACKGROUND OF THE INVENTION

This invention relates to a constant-velocity joint (CVJ) with a boot, which is used for a drive shaft of an automobile or the like.

Constant-velocity joints are available in two types, i.e. a fixed type and an axially slidable type. The fixed type can change a working angle without axially sliding and form a larger working angle than the slide type. Thus, on a front-wheel drive vehicle, fixed type CVJs are mainly used on the outboard side (connected to the wheels) and slidable type CVJs are used on the inboard side. A lubricating grease used in such CVJs contains an extreme-pressure agent to improve resistance to seizure and to reduce wear.

The reaction between such an extreme-pressure agent and a metallic surface, which is called tribo reaction, progresses with wear. Specifically, this reaction occurs due to the activation of a new metallic surface that appears due to wear and a temperature rise resulting from frictional heat. It is important to control so that such a reaction progresses at a suitable speed.

As an example of a lubricating grease for CVJs containing a plurality of extreme-pressure agents, a lithium soap grease is known which contains molybdenum disulfide and lead naphthenate.

Japanese patent publications 10-273692 and 10-273691 disclose grease compositions for CVJs each containing molybdenum dialkyldithiocarbamate, molybdenum disulfide, zinc dithiophosphate, sulfur-nitrogen extreme-pressure additive, and sulfur-family extreme-pressure additive not containing phosphorus.

Most CVJs filled with lubricating grease are provided with a bellows type boot to prevent entry of dust. A typical conventional such boot for CVJs is formed from chloroprene rubber because this particular rubber is high in oil resistance and fatigue resistance. Also, many of today's CVJ boot that are used for front-wheel drive shafts of front-drive vehicles are made from a thermoplastic polyester elastomer (e.g. HYTREL made by Dupont) because such boot are used in especially harsh conditions.

Grease in CVJs in contact with the boot tends to deteriorate the boot made from a thermoplastic polyester elastomer. Such deteriorated boot show reduced tensile strength and elongation, large change in volume, high expansion and premature fatigue.

Grease containing lead-family compounds such as lead naphthenate especially accelerates such deterioration of boot.

Such problems of CVJs with boot are common for fixed type and slidable type but marked for the former type because such CVJs can take a large working angle.

An object of the invention is to provide a constant-velocity joint having a boot made of a thermoplastic polyester elastomer and containing a lubricating grease that minimizes deterioration of the boot of the CVJ, that is, minimizes softening of the boot, lowering of its tensile strength and elongation and an increase in the volume of the boot while maintaining required torque transmission performance.

### SUMMARY OF THE INVENTION

According to the invention, there is provided a constant-velocity joint with a boot comprising a joint body filled with a lubricating grease, and a tubular boot made from a thermoplastic polyester elastomer for sealing the joint body, the grease comprising a base oil, a lithium soap as a thickener, and molybdenum disulfide, molybdenum dialkyldithiocarbamate and zinc dithiocarbamate as extreme-pressure additives.

According to the present invention, because the lubricating grease does not contain any lead compound such as lead naphthenate but contain specific extreme-pressure additives, the boot formed from a thermoplastic polyester elastomer will not deteriorate due to contact with the lubricating grease.

As a result, the constant-velocity joint with a boot formed from a thermoplastic polyester elastomer will be kept sealed against dust even after use for a prolonged period of time and exhibits durability under severe use conditions where it is subjected to earth, dust and water in a wide temperature range.

In the above-mentioned constant-velocity joint with a boot, if the lithium soap is 12 hydroxystearate lithium or a lithium complex formed by making lithium soap eutectic with a complexing agent, the lubricating grease will keep suitable hardness with little change in consistency even at high temperature and exhibit better water resistance compared with other soap group grease. Also, because a lithium complex group grease has a dropping point higher than 200° C., the joint will have better heat resistance.

Also, it is preferable that the boot is made from a thermoplastic polyester elastomer comprising 100 parts by weight of a polyester copolymer and 0.01 to 1.5 parts by weight of a glycol. It is because such a polyester elastomer improves stick-slip property (friction property) on the boot surface without impairing the durability.

The constant-velocity joint according to the present invention is applicable both to fixed type and slide type joints, but particularly suited to the former type in which the working angle changes in a wide range.

Other features and objects of the present invention will become apparent from the following description made with reference to the accompanying drawings, in which:

### BRIEF DESCRIPTION OF THE DRAWINGS

FIG. 1 is a sectional view of fixed-type constant-velocity joint embodying the invention;

FIG. 2 is a graph showing the results of endurance tests;

FIG. 3 is a graph showing the relationship between the hardness of the boot material and the time during which the boot were immersed in grease;

FIG. 4 is a graph showing the relationship between the tensile strength of the boot and the time during which the boot were immersed in grease;

FIG. 5 is a graph showing the relationship between the elongation of the boot and the time during which the boot were immersed in grease; and

FIG. 6 is a graph showing the relationship between the volume of the boot and the time during which the boot were immersed in grease.

### DETAILED DESCRIPTION OF THE PREFERRED EMBODIMENT

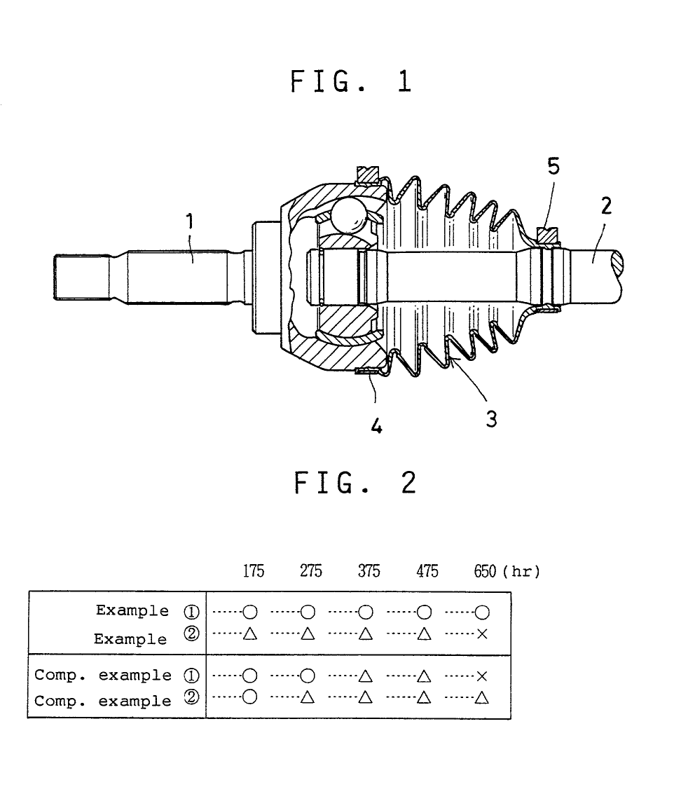

FIG. 1 shows a stationary type constant-velocity joint embodying the invention which comprises shafts 1 and 2 transmitting rotation therebetween without axially sliding and while taking a working angle. It contains a lubricating grease and is sealed by a tubular boot 3 made of a thermoplastic polyester elastomer. The bellows boot 3 has large-diameter and small-diameter open ends that are fixed to the outer periphery of the shafts 1 and 2, respectively, by clamp fasteners 4, 5.

The boot 3 has to be freely deformable when the shafts 1 and 2 pivot relative to each other, and has to seal dust in the air and water and sustain tearing by e.g. flying stones. Also, it has to be sufficiently resistant to lubricating grease, low-temperature, heat and wear. To meet all these requirements, the boot 3 is formed from a thermoplastic polyester elastomer.

The thermoplastic polyester elastomer contains as its main component a polyester block copolymer comprising a high-melting point crystalline polyester polymer segment (a) and a low-melting point polymer segment (b).

The former segment (a) is a polyester formed from an aromatic dicarboxylate or its ester-forming derivative and an aliphatic diol, and preferably a polybutylene terephthalate derived from a terephthalic acid and/or a dimethyl terephthalate and 1,4-butanediol.

The segment (a) may also be a polyester derived from a dicarboxylic acid component such as isophthalic acid, phthalic acid, naphthalene-2,6-dicarboxylate and their ester-forming derivatives and a diol having a molecular weight not exceeding 300, such as aliphatic diols including ethylene glycol, trimethylene glycol, pentamethylene glycol, hexamethylene glycol, neopentyl glycol and decamethylene glycol, and cycloaliphatic diols such as 1,4-cyclohexane dimethanol and tricyclodecane dimethylol, and aromatic diols including bis(p-hydroxy) diphenyl, bis(p-hydroxyphenyl) propane, 4,4′-dihydroxy-p-terphenyl, 4,4′-dihydroxy-p-quaterphenyl; or may be a copolymerized polyester derived from two or more of the above-described dicarboxylic acid components and two or more of the above-described diols.

The segment (a) may also be a copolymer of an aliphatic dicarboxylate such as adipic acid and sebacic acid. Also, it may be a copolymer of 5 mole % of less of multifunctional carboxylic acid components, multifunctional oxyacid components or multifunctional hydroxy components having three or more functional groups may be copolymerized.

The segment (b) is an aliphatic polyether and/or an aliphatic polyester. Aliphatic polyethers usable in this invention include poly(ethylene oxide) glycol, poly(propylene oxide) glycol, poly(tetramethylene oxide) glycol, poly(hexamethylene oxide) glycol, a copolymer of ethylene oxide and propylene oxide, an ethylene oxide-added copolymer of poly(propylene oxide) glycol, and a copolymer of ethylene oxide and tetrahydrofuran. Aliphatic polyesters usable in the invention include polycaprolactone, polyenantlactone, polycapryrolactone, polybutylene adipate, polyethylene adipate.

Among these aliphatic polyethers and aliphatic polyesters, the following are especially preferable because they improve elastic properties of the polyester block copolymer: an ethylene oxide adduct of poly(tetramethylene oxide)glycol or poly (propylene oxide) glycol, polycaprolactone, polybutylene adipate and polyethylene adipate. Preferably, the low-melting point polymer segment (b) has a number-average molecular weight of about 300-6000 in a copolymerized state.

The content of the segment (b) in the polyester block copolymer is preferably 10 to 80 wt %, more preferably 15 to 75 wt %.

Besides such polyester block copolymer, the thermoplastic polyester elastomer used as the material for the boot of the present invention contains glycol expressed by the following formula (I). Plasticiser, softener, lubricant, antioxidant and reinforcing agent may be further added.

HO(R₁O)xH (I)

(wherein R₁ is a functional group which is a hydrocarbon compound having a carbon number of 1 to 6 with two hydrogen removed. X is an integer of 1 to 1000.)

Glycols expressed by formula (I) include poly(ethylene oxide) glycol, poly(propylene oxide) glycol, poly(tetramethylene oxide) glycol, poly(pentamethylene oxide) glycol and poly(hexamethylene oxide) glycol. Among them, poly(tetramethylene oxide) glycol is especially preferable. Glycols having a number of repeating units x of 10-500 are easily commercially available and thus preferable.

The glycol expressed by formula (I) is added by 0.01-1.5 parts by weight to 100 parts by weight of the polyester block copolymer.

The lubricating grease used in this invention has its base oil thickened by a lithium soap and contains molybdenum disulfide, molybdenum dithiocarbamate and zinc dithiocarbamate as extre-pressure additives.

The base oil may be any of a mineral oil, synthetic ester oil, synthetic ether oil, and synthetic hydrocarbon oil. It may be a mixture of two or more of them.

The lithium soap used as the thickener is a metallic soap obtained by saponifying lithium hydroxide and a fatty acid. The fatty acid is preferably a purified stearic acid having a carbon number of 18 or a 12 hydroxy stearic acid. Such a lithium soap has high water resistance and good structural stability for serving as a thickener.

The lithium complex is formed by making eutectic a lithium soap and a complexing agent. By using a lithium complex as a thickener, the dropping point of the grease increases to 200° C. or over. Lithium complex is a thickener having a high heat resistance. Complexing agents usable include dibasic acid or its ester, succinic imide, boric acid, phosphoric acid and salycylic acid.

The content of the thickener (lithium soap) in the lubricating grease used in this invention is 1-25 wt % and preferably 5-20 wt %.

If it exceeds the range, the consistency would be too small for lubricating. If under the range, the thickening power would be insufficient for the constant-velocity joint to exhibit required shear stability.

Molybdenum disulfide used as the extreme-pressure agent may be one used generally as a solid lubricant. Molybdenum disulfide has a layered lattice structure, so that slip occurs easily between its layers under shearing load. This prevents metal-to-metal contact and seizure of two metallic surfaces that are in frictional contact with each other through molybdenum disulfide.

The content of molybdenum disulfide required to achieve this purpose is 0.1-5 wt %. Too much an amount of molybdenum disulfide might increase the friction coefficient and thus cause wear.

Molybdenum dialkyldithiocarbamate used in this invention is preferably one expressed by the formula (II), which is known as a solid lubricant.

[R¹R²N—CS—S]₂—Mo₂OₘSₙ

wherein R¹ and R² are alkyl groups having a carbon number of 1 to 24, m+n=4, m=0 to 3, n=4 to 1.

Specific molybdenum dialkyldithiocarbamates expressed by formula (II) include one expressed by the chemical formula 1.

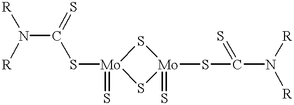

(wherein R is a primary or secondary alkyl group or aryl group)

Molybdenum dialkyldithiocarbamate should be added by 0.1-5 wt %. If its content is less than 0.1%, it will not sufficiently increase wear resistance and extreme-pressure properties. Adding more than 5 wt % of this substance will not improve or even deteriorate the expected properties, but cause cost increase.

Zinc dithiocarbamate used in the invention is represented by a compound expressed by the following formula 2.

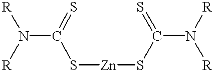

(wherein R is a primary or secondary alkyl or aryl group)

It should be added by 0.1-10 wt %. If its content is less than 0.1%, it will not sufficiently reveal expected properties. Adding more than 10 wt % will not improve or even deteriorate the expected properties, and cause cost increase.

### EXAMPLES AND COMPARATIVE EXAMPLE

A lubricating grease was prepared in a known manner by adding 10 wt % of a thickener which was lithium soap containing 12 hydroxystearic acid as a fatty acid to a mineral oil as a base oil, and further adding 2 wt % of molybdenum disulfide, 3 wt % of molybdenum dialkyl dithiocarbamate and 3 wt % of zinc dithiocarbamate.

The grease obtained was charged into a constant-velocity joint and a boot made from a thermoplastic polyester elastomer (HYTREL made by Toray-Dupont) was mounted to the joint as shown in FIG. 1 (Examples of the Invention).

A commercially available grease (comprising mineral oil as a base oil, lithium soap as a thickener, and molybudenum disulfide and lead naphthenate) was charged into a constant-velocity joint of the same type shown in FIG. 1 by the same amount as the grease of Example and a boot made from a thermoplastic polyester elastomer (HYTREL made by Toray-Dupont) was mounted on the joint (Comparative Example).

The CVJs of Examples and Comparative Examples were subjected to (A) high-temperature heat cycle test and (B) high-load endurance test under the following conditions. (A) High-temperature heat cycle test

With the input and output members of the CVJ forming a predetermined working angle, each joint was subjected to a 10-cycle test in which the cycle of continuously rotating each joint at a medium speed for a predetermined time period at 100° C. and then standing it at room temperature was repeated 10 times. After the test, the inner surface of the boot was observed to determine if any cracks were formed.

Cracks were observed in the inner surface of the boot of Comparative Examples. No cracks were found in the boot of Examples.

(B) High-load Endurance Test

With the input and output members of the joints forming a predetermined working angle, each joint was rotated for 650 hours at room temperature with a constant load applied. The interior of each CVJ was observed to determine if there existed any damage after lapse of 175, 275, 375, 475 and 650 hours. The results are indicated in Table 2 in three stages, i.e. good (◯), which means that no damage was observed inside the joint, passable (Δ), which means that minor wounds were found inside the joint but continuous operation was possible, and no good (×), which indicates that severe damage was found and the joint was inoperative any further.

It was found out that the joint of any Example and Comparative Example survived operation at least 600hour (see FIG. 2).

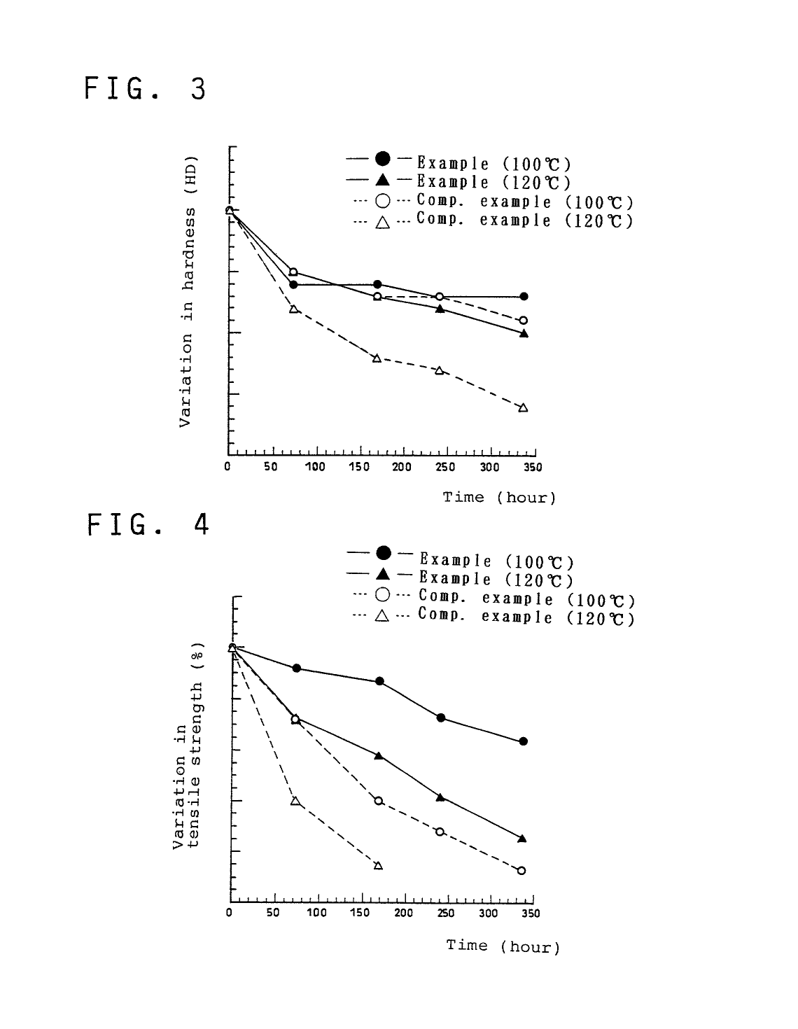

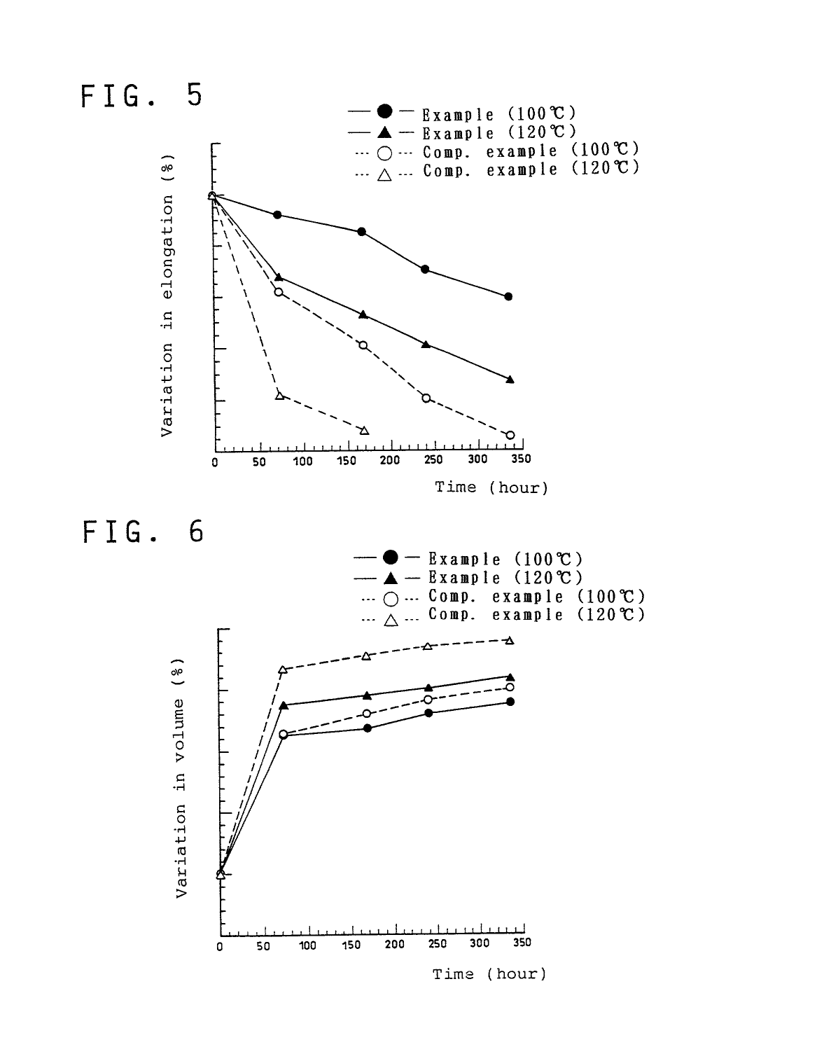

Next, changes in the physical properties when the boot material formed of a thermoplastic polyester elastomer was immersed in lubricating greases of the Examples and Comparative Examples were measured. The results are shown in FIGS. 3 to 6.

CVJ boot made of a thermoplastic polyester elastomer (HYTREL made by Toray/Dupont) was immersed in the grease (100° C. or 120° C.) of Examples of the invention and the grease (100° C. or 120° C.) of Comparative Examples and the respective boot were tested after 70, 170, 240 and 350 hours for the following properties:

(a) hardness (measured by type D durometer under JIS K6253),

(b) tensile strength (measured under JIS K6251, JIS K6258),

(c) elongation (measured under JIS K6251, JIS K6258)

(d) volume (measured under JIS K6258)

As will be apparent from FIGS. 3-6, the boot material immersed in the grease of Comparative Examples softened markedly, their tensile strength and elongation decreased markedly, and their volumes increased markedly, when compared with the boot immersed in the grease of Examples.

The boot material immersed in the grease of Examples showed less softening, less decrease in its tensile strength and elongation, and less increase in the volume of the boot, compared with the comparative Examples.

Because the constant-velocity joint according to the present invention has a boot made of a thermoplastic polyester elastomer and uses a lubricating grease containing specific extreme-pressure additives, it can maintain a required torque transmitting property and the boot will not deteriorate due to contact with the lubricating grease, not soften, nor show any decrease in the tensile strength or elongation, and the degree of expansion or change in volume is small.

The 12 hydroxystearate lithium or a lithium complex used as lithium soap in the thickener improves the heat resistance of the joint.

Even if the CVJ is of the type that can take a large working angle (such as an axially non-slidable CVJ), the boot according to the invention is less likely to be torn or otherwise damaged because it is high in elasticity and thus is deformable following the movement of the input and output members of the CVJ.

What we claim:

1. A constant-velocity joint with a tubular boot comprising a joint body filled with a lubricating grease, and said boot being made from a thermoplastic polyester elastomer for sealing said joint body, said grease comprising a base oil, a lithium soap as a thickener, and molybdenum disulfide, molybdenum dialkyldithiocarbamate and zinc dithiocarbamate as extreme-pressure additives.

2. The constant-velocity joint with a boot as claimed in claim 1 wherein said lithium soap is 12 hydroxystearate lithium or a lithum complex formed by making eutectic a lithium soap with a complexing agent.

3. The constant-velocity joiny with a boot as claimed in claim 1 or 2 wherein said thermoplastic polyester elastomer comprises 100 parts by weight of a polyester copolymer and 0.01 to 1.5 parts by weight of a glycol.

4. The constant-velocity joint with a boot as claimed in any of claims 1-3 wherein the joint is a fixed type comprising an input member and an output member which can take a working angle without axially sliding relative to each other.
